(19) United States
(12) Patent Application Publication
(10) Pub. No.: US 2007/0279900 A1
(43) Pub. Date: Dec. 6, 2007

(54) Submersible LED Light Fixture System

(75) Inventors: Michael Bauer, Orlando, FL (US); Roy Archer, Orlando, FL (US); Stephen Faber, Orlando, FL (US); Paul Koren, Altamonte Springs, FL (US)

Correspondence Address: AKERMAN SENTERFITT, P.O. BOX 3188, WEST PALM BEACH, FL, 33402-3188, US

(73) Assignee: Nexxus Lighting, Inc., Orlando, FL (US)

(21) Appl. No.: 11/761,857

(22) Filed: Jun. 12, 2007

Related U.S. Application Data
(63) Continuation-in-part of application No. 11/265,691, filed on Nov. 1, 2005.

(51) Int. Cl. F21V 31/00; F21V 15/01

(52) U.S. Cl. 362/158; 362/249

(57) ABSTRACT

A light fixture system is provided including a plurality of light fixtures coupled to a common power supply line, where each of the plurality of light fixtures has an LED light engine and a control module configured to adjust light output settings for the LED light engine based on a plurality of electrical power signal patterns transmitted over the common power supply line. A first control module of a first light fixture can be configured to provide a first response based on a first of the plurality of electrical power signal patterns and a second control module of a second light fixture can be configured to provide a second response based on the first of the plurality of electrical power signal patterns. The first response can include the first control module being at least temporarily unresponsive to at least a second of the plurality of electrical power signal patterns.

### CROSS-REFERENCE TO RELATED APPLICATIONS

This application is a continuation-in-part application of U.S. patent application Ser. No. 11/265,691, filed Nov. 1, 2005, the disclosure of which is hereby incorporated by reference.

### FIELD OF THE INVENTION

This invention is directed generally to light emitting diode (LED) fixtures, and more particularly, to submersible LED light fixtures for use underwater in swimming pools, spas and the like.

### BACKGROUND OF THE INVENTION

Generating visible light with traditional light sources, such as incandescent or fluorescent light sources, is inefficient because thermal energy is also produced as by-product of the process. The wasted thermal energy is generally directed away from the light source in the direction of the radiant beam of light. Fixtures such as light shades or reflectors, or even the target illuminated by the light source, receive the wasted thermal energy, and consequently, rise in temperature. In some instances, the rise in temperature can reduce the useful life of a product. Further, the arrangement of traditional light sources are limited to designs that can withstand the wasted thermal energy. In underwater applications, wasted thermal energy is typically dissipated into the water, however, this does not prevent the light fixtures from having a relatively short life due to this excess heat.

It is also known to use fiber-optic cables for underwater lighting, but fiber-optic lighting is expensive and difficult to install, and is not suitable for the retro-fitting of existing pools. Additionally, the fiber-optic light fixtures are not as bright as traditional incandescent light fixtures, and are therefore not well used in pool and other underwater lighting applications.

In contrast to traditional light sources, solid state lighting, such as light emitting diode (“LED”) fixtures, are more efficient at generating visible light than many traditional light sources. However, single LED lights are typically not bright enough for illuminating objects or for use in pool and other underwater lighting. In order to use LEDs for illumination, a cluster of LED fixtures must be provided. Although LEDs do not generally radiate heat in the direction of the beam of light produced, implementation of LEDs for many traditional light source applications has been hindered by the amount of heat build-up within the electronic circuits of the LEDs. This heat build-up is particularly problematic as more LEDs are added to a cluster. Heat build-up reduces LED light output, shortens lifespan, and can eventually cause the LEDs to fail.

Accordingly, heat sinks have been used to dissipate heat away from LEDs; however, in the past, LEDs have been thermally coupled to heat sinks with adhesive tapes. The use of adhesive tape introduces several problems, such as the labor and time intensive process of providing tape for each individual LED. Further, adhesive tapes are susceptible to being displaced during the assembly process, resulting in less than optimal heat dissipation. Particular problems arise when the light fixture is intended for use underwater in a swimming pool, spa, fountain, sink or other water feature. Not only must a heat sink be provided, it must be able to withstand being submerged. For example, it is not possible to use adhesive tape to connect an LED to a heat sink in a fixture designed to be submerged, because the adhesive can dissolve in water, causing the connection to the heat sink to be broken.

LED light engines have recently become available, which supply multiple LED lights in an array. The light engines make it possible to provide a high lumen light using LEDs, and it is desirable to use such light engines in swimming pool, spa and other underwater lighting. However, the management of heat generated by the light engines is critical to maintaining the performance of the LED array, and it is therefore desirable to be able to package an LED light engine in such a way that it can be used in underwater applications.

### SUMMARY OF THE INVENTION

In a first arrangement of the present disclosure, a light fixture system is provided comprising a plurality of light fixtures coupled to a common power supply line, where each of the plurality of light fixtures comprises an LED light engine and a control module coupled thereto, where the control module can be configured to adjust light output settings for the LED light engine based on a plurality of electrical power signal patterns transmitted over the common power supply line. The first control module of a first light fixture is configured to provide a first response based on a first of the plurality of electrical power signal patterns. A second control module of a second light fixture is configured to provide a second response based on the first of the plurality of electrical power signal patterns. The first response comprises the first control module being at least temporarily unresponsive to at least a second of the plurality of electrical power signal patterns.

In a second arrangement of the present disclosure, a method of adjusting light output in a submersible light fixture system is provided, where the method comprises coupling a plurality of fixtures to a common power supply line, where at least one of the plurality of fixtures is a submersible light fixture and where each of the plurality of fixtures comprises an LED light engine coupled to a control module. The method also comprises transmitting a plurality of electrical power signal patterns along the common power supply line to the plurality of fixtures, where each of the control modules is configured to adjust light output settings for the LED light engine coupled thereto in response to at least a portion of the plurality of electrical power signal patterns and where a first control module of a first fixture is configured to provide a first response based on a first of the plurality of electrical power signal patterns and a second control module of a second fixture is configured to provide a second response based on the first of the plurality of electrical power signal patterns. The first response comprises the first control module being at least temporarily unresponsive to at least a second of the plurality of electrical power signal patterns.

In a third arrangement of the present disclosure, a method of adjusting a light output of a plurality of submersible light fixtures installed in multiple areas is provided, where the method comprises electrically coupling the plurality of submersible light fixtures to a common power supply line, where each one the plurality of submersible light fixtures comprises an LED light engine coupled to a control module and where the common power supply line is coupled to a power supply using at least one switch, and wherein the control module for each one of the plurality of submersible light fixtures is configured to adjust light output settings of the coupled LED light engine in response to at least one of a plurality of power signal patterns transmitted along the common power supply line. The method also comprises generating the plurality of power signal patterns by opening and closing of the at least one switch for a pre-determined interval of time, where a first power signal pattern is generated based on a first pre-determined interval of time, with the first power signal pattern adjusting the light output of the plurality of submersible light fixtures to a first light output setting, and where a second power signal pattern is generated based on a second pre-determined interval of time, with the second power signal pattern adjusting the light output of at least one of the plurality of submersible light fixtures to a second light output setting and causing at least another of the plurality of submersible light fixtures to be at least temporarily unresponsive to subsequent power signal patterns.

These and other arrangements and advantages are described in relation to the accompanying drawings.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a perspective view of a submersible light fixture according to the inventive arrangements.

FIG. 2 is an exploded perspective view of the submersible light fixture of FIG. 1.

FIG. 3 is an exploded perspective view of another submersible light fixture according to the inventive arrangements.

FIG. 4(a) is side view of a submersible light fixture according to the inventive arrangements.

FIG. 4(b) is side view of another submersible light fixture according to the inventive arrangements.

FIG. 5 is a side view of the sleeve and LED light engine used in the submersible light fixture of FIG. 1.

FIG. 6 is an exploded view of a submersible light fixture installed in an existing niche according to the inventive arrangements.

FIG. 6A is an exploded view of another submersible light fixture that can be installed in an existing niche according to the inventive arrangements.

FIG. 7 is a perspective view of the submersible light fixture of FIG. 6 mounted in a support bracket according to the inventive arrangements.

FIG. 8 is a perspective view of the sleeve and LED light engine of FIG. 5

FIG. 9 is a plan view of a portion of the sleeve and LED light engine of FIG. 5

FIG. 10 is an enlarged plan view of the LED light engine of FIG. 8.

FIG. 11 is an exploded perspective view of an exemplary LED array according to the inventive arrangements.

FIG. 12(a) is a front view showing an alternate arrangement of the submersible light fixture, using an alternate LED light engine according to the inventive arrangements.

FIG. 12(b) is a front view showing an alternate arrangement of the submersible light fixture, using an alternate LED light engine and a solderless LED light engine mount according to the inventive arrangements.

FIG. 13 is a top and side view of a solderless LED light engine mount for use in the LED light engine of FIG. 12(b).

FIG. 14 is a circuit diagram for a submersible light fixture according to the inventive arrangements.

FIG. 15 is an exemplary schematic of the arrangement for the components of a submersible light fixture system according to the inventive arrangements.

### DETAILED DESCRIPTION OF THE DRAWINGS

The present invention provides light emitting diode (LED) fixtures, and more particularly, submersible LED light fixtures for use in swimming pools, spas and the like. It will be appreciated that the LED fixtures can be used in any suitable underwater application such as swimming pools, spas, fountains, sinks, waterfalls or any other water feature, and is not limited in this regard.

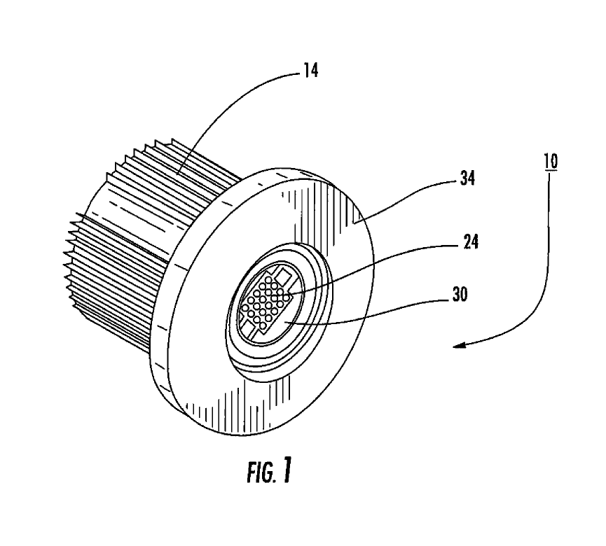

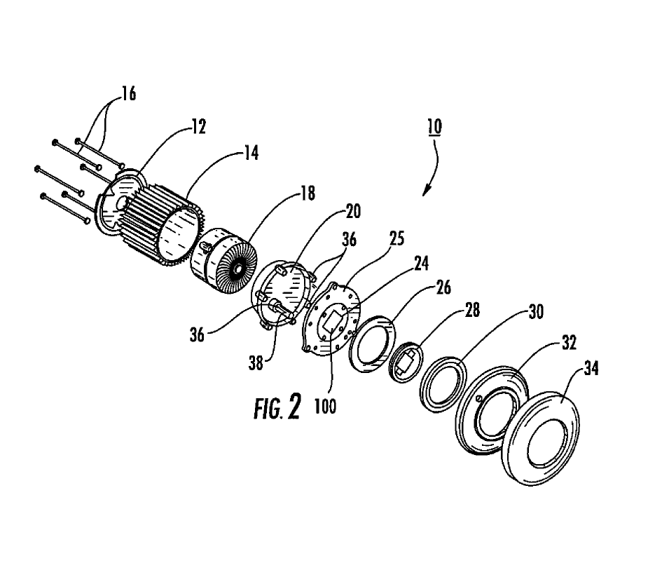

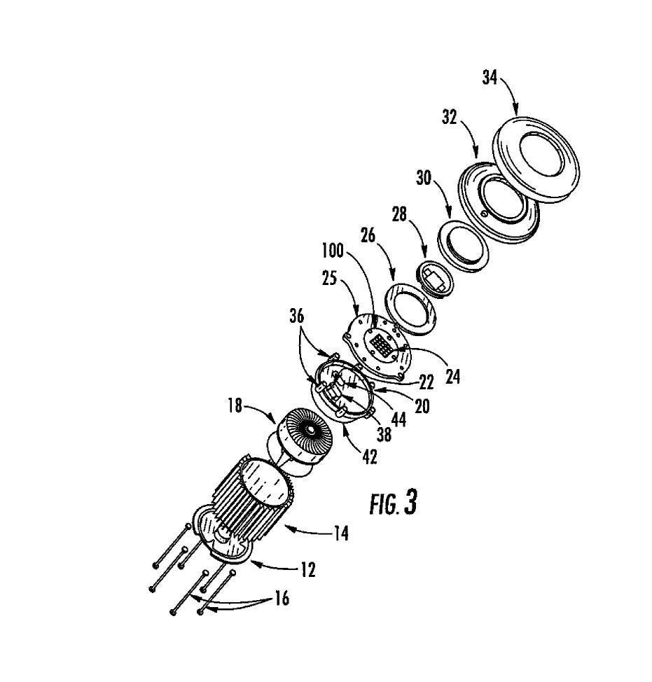

An arrangement of the present invention is illustrated in the accompanying drawings. For example, FIGS. 1-4, show a submersible LED light fixture according to the present invention. The light fixture 10 can include a base plate 12, which can be mounted to a ribbed outer sleeve 14 by screws 16. A control module 18 can be located within the sleeve 14, and the sleeve can be capped by a cap 20. The cap 20 can include an aperture for an electrical connection 22 to a light engine 24 that can be mounted on a metallic plate 25. The light engine 24 can be protected from water by a lens arrangement including an annular washer 26, a spacer 28, a lens 30, a lens collar 32, and an outer collar 34.

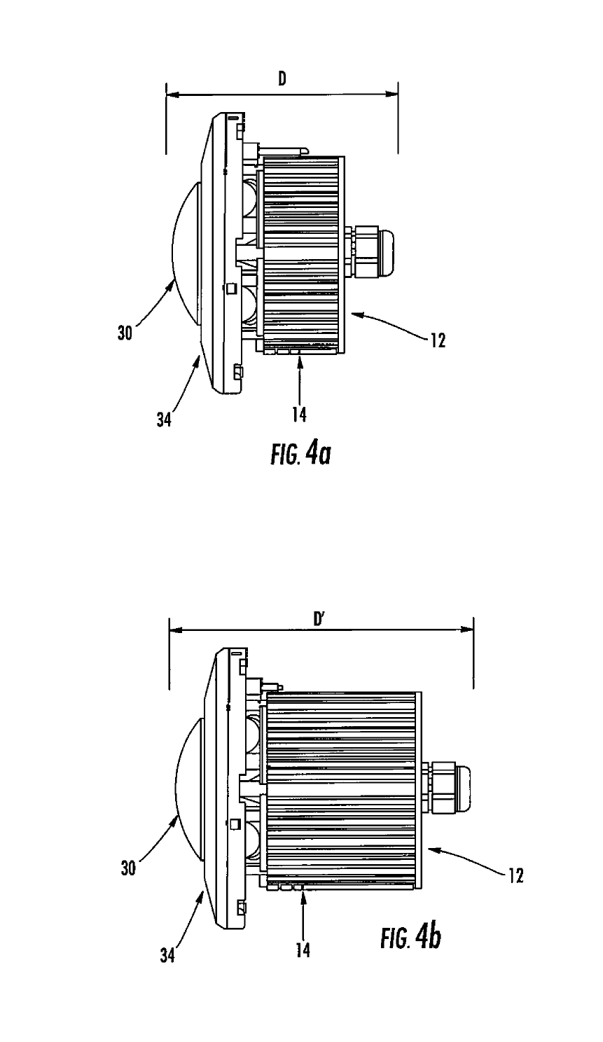

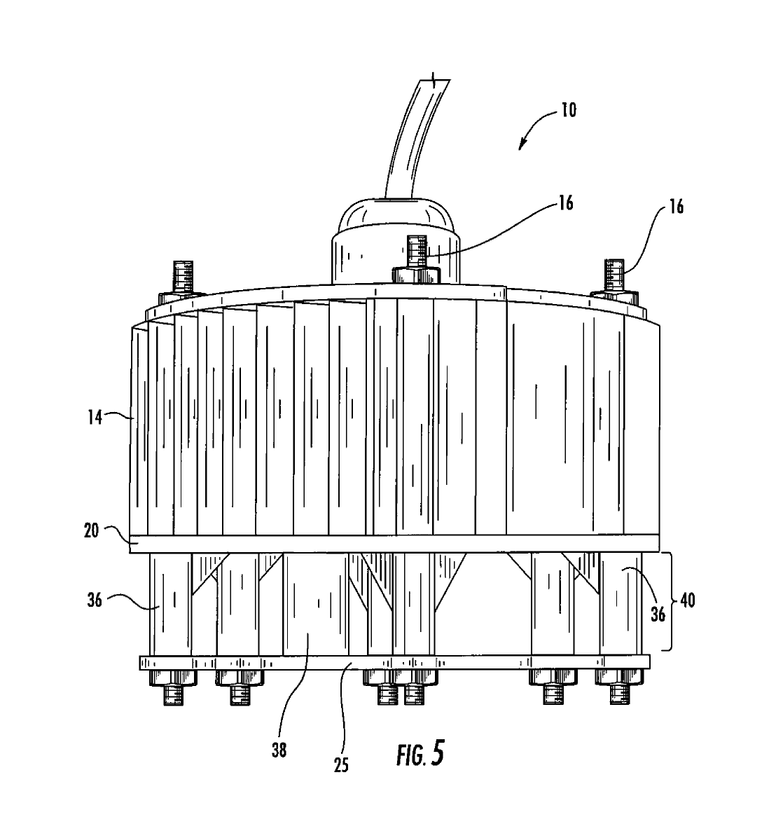

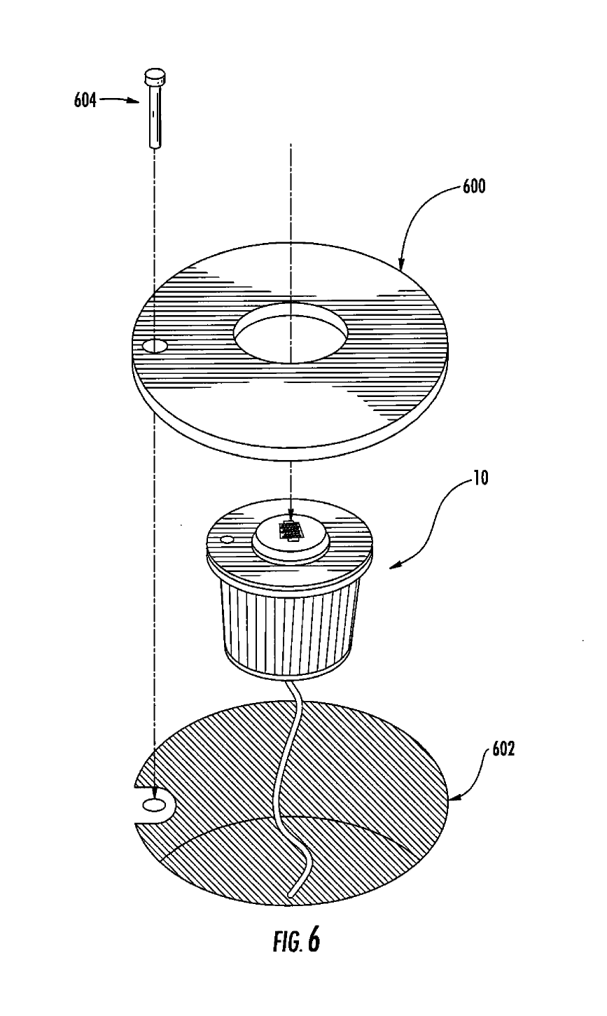

The base plate 12 can be formed of a heat conducting material, such as a metallic or thermally conductive ceramic material. The sleeve 14 and the cap 20 can also formed of any suitable material, and are preferably formed of a plastic or nylon material to provide a watertight, non-electrically conducting housing for the control module 18. The dimensions of the sleeve 14 can vary according to the application. For example, a sleeve 14 having a longer length (D′), as shown in FIG. 4, can be provided to accommodate, for example, a larger control module 18 or an electrical transformer. Alternatively, a sleeve 14 having a shorter length (D) can be used where the wall at an installation site is of a thinner thickness or where an electrical transformer is not needed. In at least some configurations, the sleeve length can range between 2 to 4 inches, inclusively.

The cap 20 can be configured to have several protrusions 36 extending therefrom, which form sleeves for the screws 16. The screws 16 can extend through the cap 20, and can be used to secure the metallic plate 25 to the base plate 12 and ribbed outer sleeve 14. A watertight connection can be further secured using an o-ring or gasket 42. In the illustrated embodiment, there are six protrusions 36 because there are six screws 16, but any number of screws can be used. A sleeve 38 can also surround and extend from the electrical connection aperture 22. A watertight connection between the connection aperture 22 and the plate 25 can also be further secured using an o-ring or gasket 44. Additionally, the sleeves 36, 38 can be used to allow the metallic plate 25 to be positioned away from the cap 20, creating a gap 40 between the cap 20 and the plate 25. Although increasing the size of the gap 40 increases the amount of water circulating to cool the plate 25, a gap 40 of as small as 0.65 inches can be used and still effectively cool the light engine 24.

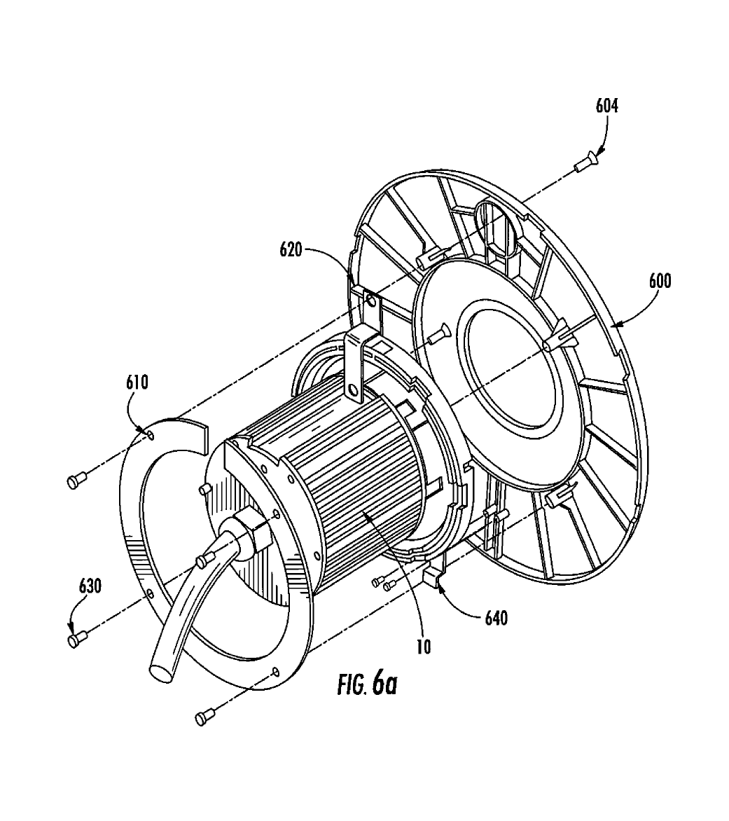

The light fixture 10 can be mounted in a niche or opening in a wall or other underwater surface of a swimming pool, spa or other water feature, as shown in FIG. 6. In some arrangements, the light fixture 10 may be used to replace a previously installed light fixture, using existing wiring. In such arrangements, an adapter 600 may be needed to properly install the light fixture 10 into a niche 602 designed for a larger light fixture. The light fixture 10 can first be attached to the adapter 600 using one or more fasteners, however the light fixture 10 can also be attached to the adapter 600 using a system of clips, locking tabs, or a locking rotational arrangement. Once the light fixture is attached to the adapter 600, the adapter 600 can be installed into the niche 602, using at least one fastener 604 or the attachment mechanism for the previously installed light fixture 10. When the light fixture 10 is mounted in a niche of a swimming pool, spa or other water feature, it can be mounted such that the gap 40 is open to and in fluid communication with the water. The water can enter into the gap, and directly contact the plate 25 to form a heat sink that is used to cool the light engine 24.

In one embodiment shown in FIG. 6A, the adapter 600 is secured to the niche (not shown) through use of the fastener 604, a retaining clip 610, a plurality of fasteners 630 and a spring clip 640. The retaining clip 610 and spring clip 640 can be connected to the adapter 600 by the plurality of fasteners 630 and the clip can then be secured into the niche by the fastener 604. A grounding bracket 620 can be utilized and secured to the light fixture 10. The present disclosure contemplates the use of other configurations of fasteners, fastening structures and techniques as well.

As used herein, a light engine is any optical system that can collect light from a lamp, such as light emitting diode (LED), and deliver the light to a target, which can be used by the target or can be reformatted, such as improving spatial, angular and/or spectral uniformities of the light. Additionally, the light engines can feature one or more LEDs, which can all be a single color or can be various colors.

Typically, proper cooling is necessary for a light engine. For example, in the case of LED light engines, such light engines should be operated at or below 125° C. for optimal performance. This is because LEDs are sensitive to heat and must be kept below this temperature to avoid severe degradation and catastrophic failure of the LED. In addition, lifetime and light output decreases with increasing temperature, even if the LED is kept below 125° C. A heat sink must therefore be attached to the array with sufficient cooling capacity to keep the die junction below 125° C. To ensure such proper cooling in at least one arrangement, the electrical connection 22, and sleeve 38 can be positioned off-center from the center of the light engine 24 so that the center of a light engine 24, which typically has the highest temperatures, can be in direct thermal communication with the water in the gap 40 through the plate 25. Additionally, the water can travel down the sides of the ribbed sleeve 14 and can then contact the base plate 12. The base plate 12, which in a preferred arrangement is metallic, can then dissipate heat from the control module 18 into the body of water.

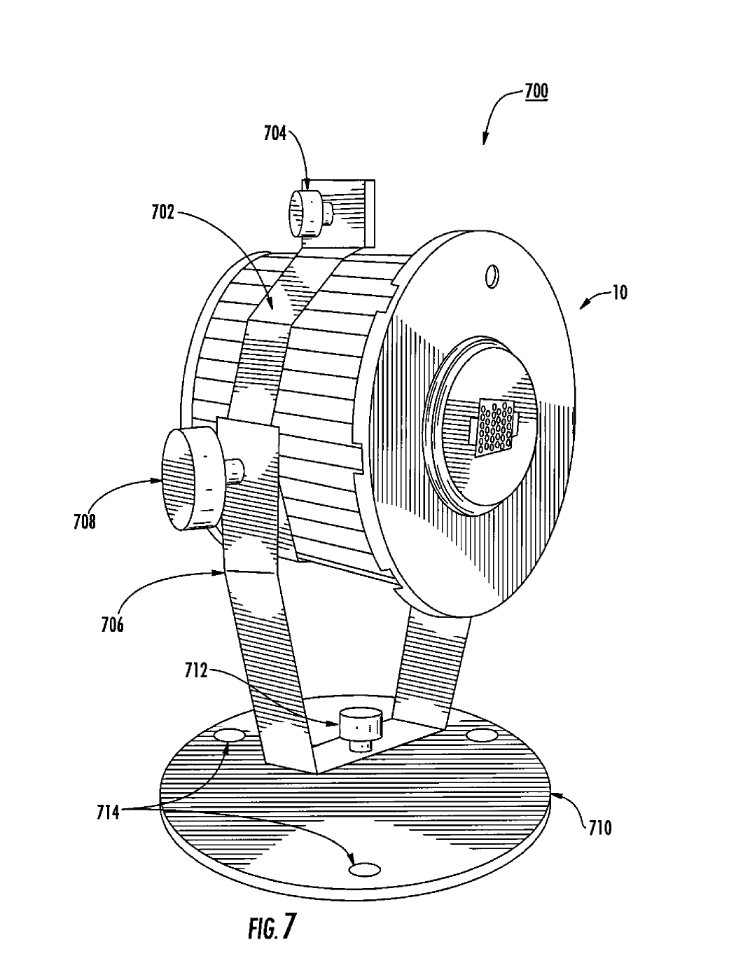

In some arrangements, the light fixture 10 can be mounted in a support bracket 700, as shown in FIG. 7. Such arrangements allow the light fixture to be securely installed where the light fixture cannot be installed in a wall or an existing niche. Damage to the light engine 24 from overheating can be prevented by ensuring that the support bracket is configured to support the light fixture 10 without blocking the gap 40, thus allowing water to circulate through the gap 40 and cooling the plate 25. However, bracket 700 could also be used to mount the light fixture 10 above water, provided sufficient cooling for the light engine 24 can be provided, such as from flowing water from a fountain, waterfall, or the like.

In an exemplary arrangement as shown in FIG. 7, the support bracket can comprise a support strap or wrap 702 secured around the sleeve 14 with a fastener 704. However the light fixture 10 can also be attached to the support bracket 700 using one or more screws, clips, or other types of fasteners. The support wrap 702 can be attached to a support frame 706. In some arrangements, the support wrap 702 can be pivotably mounted in the support frame 706, allowing the light fixture 10 to tilt or rotate relative to the support frame 706. One or more fasteners 708 can also be used to secure the tilt angle of the light fixture 10. Additionally, the support frame can be attached to a base 710 or attached to a surface. In some arrangements, the support frame can be pivotably attached to the base 710, allowing the light fixture to be rotated. One or more fasteners 712 can also be used to secure the rotation angle of the light fixture 10 and support frame 706. The base 710 can also be secured to a surface using fastener in one or more openings 714 in the base 710 or can simply sit on a level surface. Such brackets 700 allow the light fixture 10 to be mounted and to direct their light output in a specific direction.

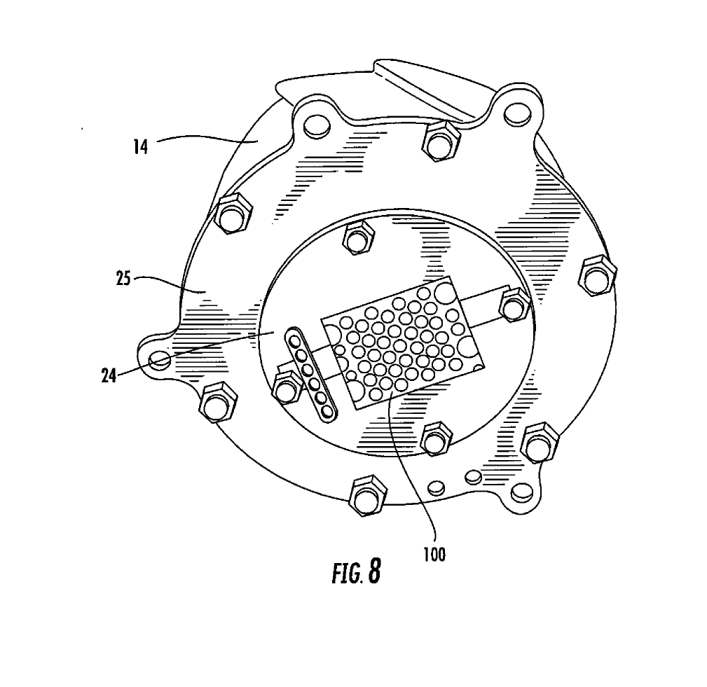

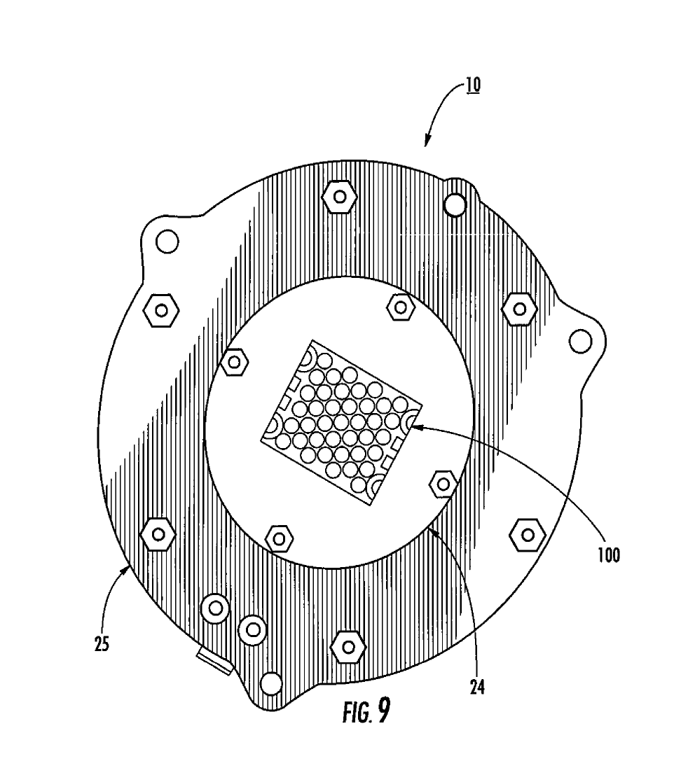

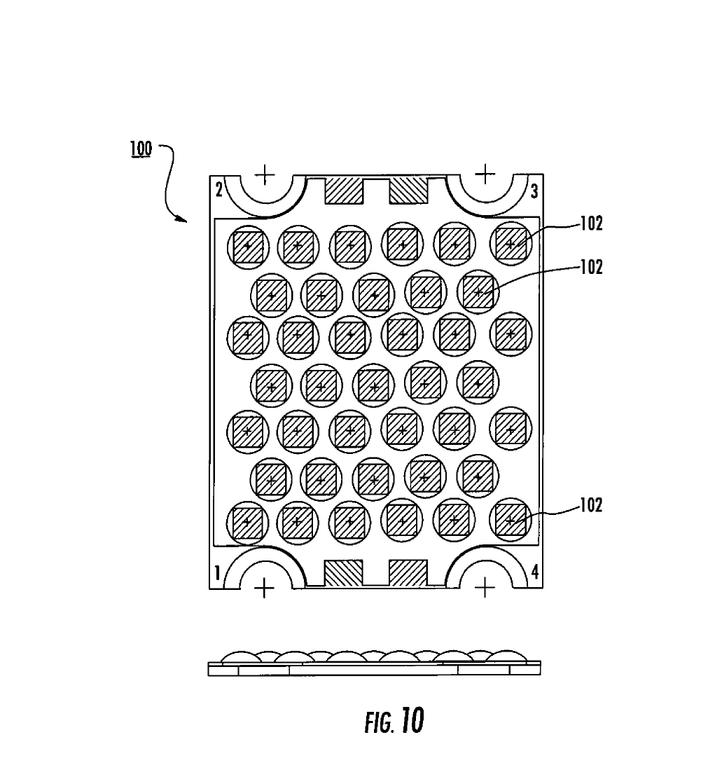

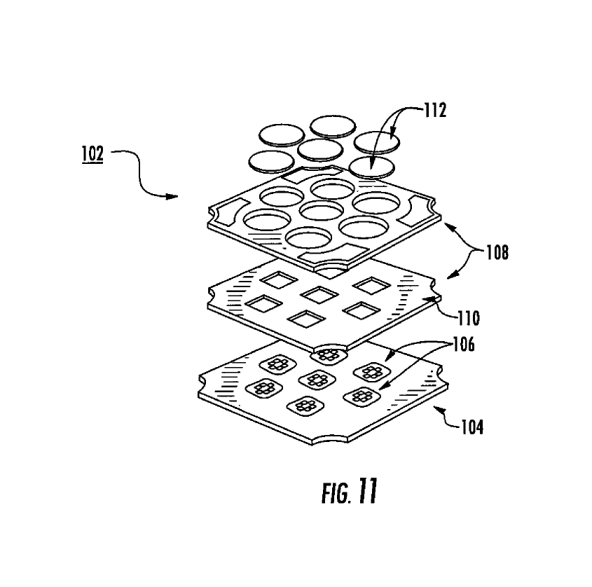

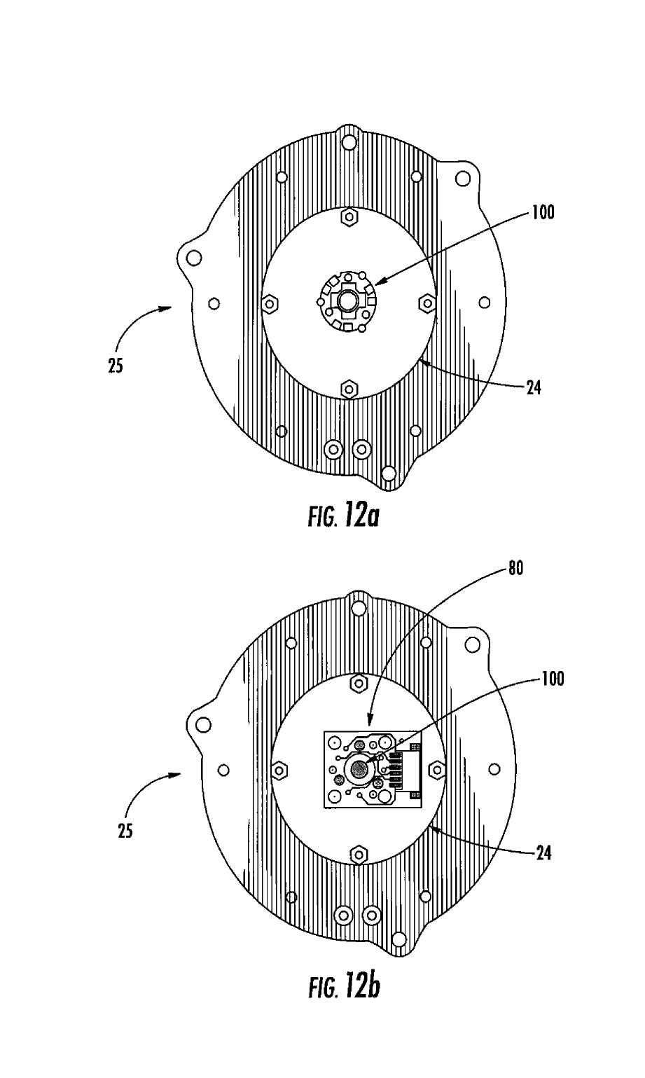

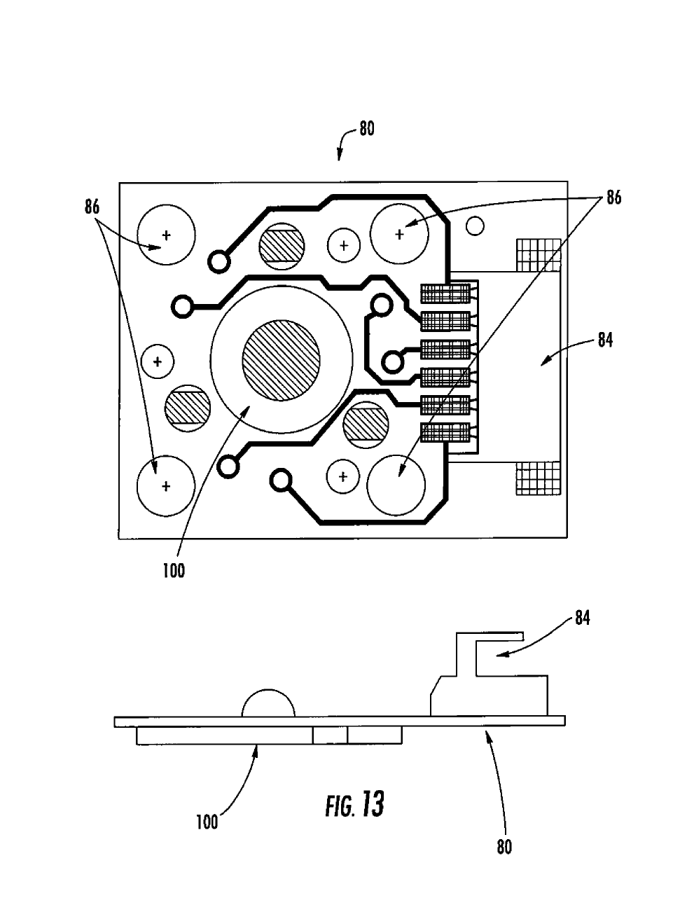

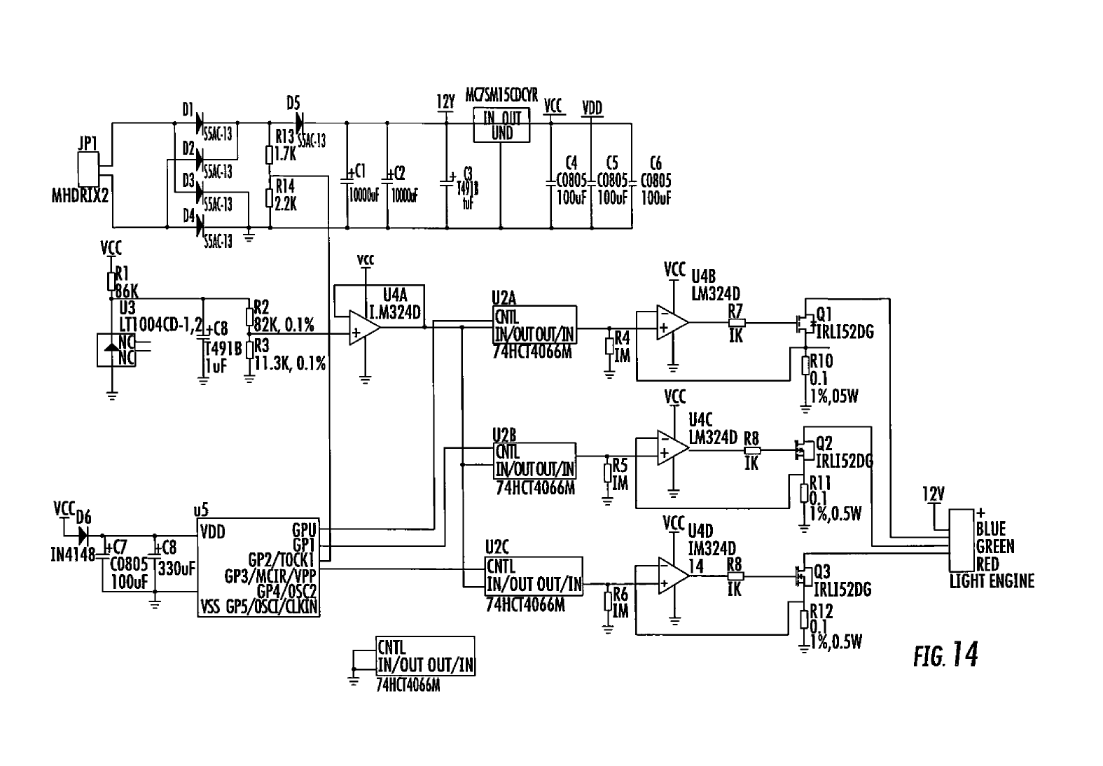

A LED light engine 100 can be manufactured by combining high brightness LEDs with a multilayer low temperature co-fired ceramic on metal (LTCC-M). The LTCC-M allows multiple LEDs to be densely clustered to achieve high luminous intensity in a small array. A suitable LED light engine for use in this invention is the BL-3000 RGB light engine available from Lamina Ceramics of Westhampton, N.J. The BL-3000 LED array is configured with 39 cavities, each populated with multiple LEDs. In a RGB light engine, each cavity contains multiple red, green and blue LED dies for optimal color uniformity. An exemplary arrangement for the LED light engine 100 is illustrated in FIGS. 8, 9 and 10, and shows 39 LED arrays 102. An individual LED array 102 is illustrated in FIG. 10, and comprises a metal composite base 104, a plurality of LEDs 106, ceramic layers 108, at least one of which has electrical traces 110 thereon, and lenses 112.

In the exemplary arrangement of LED arrays 102 for a LED light engine 100, the LEDs 106 can be mounted directly to the metal composite base 104, which can be a nickel-plated, copper-molybdenum-copper composite, or any suitable metal composite. The base 104 can be formed of a single metal such as copper or aluminum, which are traditionally used for packaging LEDs, but a metal composite, such as the nickel-plated, copper-molybdenum-copper composite used in the example LED light engine has been found to have a thermal coefficient of expansion that is similar to the typical LED chip material. This similarity ensures compatibility of the LED and substrate through a lifetime of heating and cooling as the LEDs are powered on and off, and reduces mechanical stress caused by the expansion and retraction created during heating and cooling cycles.

It will of course be appreciated that any number of LEDs can be used, and that any suitable LED array or light engine can be employed in the present invention. Other suitable RGB LED light engines using a different number of LEDs are the BL-4000 RGB light engine and the Atlas LED light engine, both available from Lamina Ceramics of Westhampton, N.J. The BL-4000 and the Atlas light engines are both configured with a single cavity, where each cavity contains only six LEDs, evenly divided among red, green, and blue LEDs for optimal color uniformity. Such smaller light engines can be used in smaller water features, such as a spa or fountain, where the light output requirements are not as high. Such smaller light engines can also be used when it is desired to reduce the power use requirements for lighting a water feature. Furthermore, because such smaller light engines generate a reduced amount of heat, reducing the amount of degradation of the LED light engine, increasing overall lifetime and performance. Furthermore, the reduced generation of heat also reduces the required amount of cooling so that a light fixture 10 can be operated in water features operating at higher temperatures, such as in a heated spa. Alternatively, such light fixture 10 can rely on air flow, rather than water flow, to cool the LED light engine 100.

Although a LED light engine 100 can be mounted directly on the a thermally conducting plate of the light engine 24, in some arrangements, a LED light engine 100 can also be mounted using a connection board 80 mounted on light engine 24. In some arrangements, the connection board 80 can be configured to allow the LED light engine 100 to be mounted in the light fixture 10 without requiring the use of soldering. This can allow the LED light engine 100 to be replaced more easily in case of failure. Furthermore, the connection board 80 can also include a connector 84 to further reduce the amount of soldering required for wiring and simplify replacement of the connector board 80 and/or construction of the light fixture 10. Additionally, the connection board can be configured to allow additional lens housings (not shown) to snap fit into apertures 86 for easy installation and removal, without removal of the connector board 80 or the LED light engine 100.

A light fixture 10. used in the present invention can be in communication with a control console (not shown) operating a lighting network in compliance with the DMX512, DMX512/1990 or DMX512-A protocols, or any extensions thereof. These protocols can specify the transmission voltages, the data rate, the format of the data content, the type of cable and the type of connector to be used. The DMX protocols additionally can be used to specify the color of the light output by the LED light engine 100, which can change over time or in a programmed sequence to give a pleasing effect from the light fixture 10. Typically, a plurality of light fixtures 10 can be mounted in the walls of a pool, spa or the like, and varying light colors can be generated in each individual light fixture 10, and also as a sequence or pattern across the plurality of fixtures. The submersible light fixture 10 can thus generate lighting effects that are not possible to achieve with current submersible lights in single or multiple areas.

Typically, a control console is used to control the light output of multiple light fixtures 10, however, in some circumstances a control console is either unavailable or impractical. For example, one circumstance can comprise using the light fixture in a retrofit application. Many existing pools, spas, or other water features utilize light fixtures operating light sources and associated wiring which are typically designed for on/off operation. In such applications, installation of a control console and associated control wiring can be costly, impractical, or even impossible with the existing configuration for the water feature. Therefore, it is often desirable not only to install the light fixture 10 using existing wiring, but also to be able to operate and adjust the light output of the light engine 24 without the use of a control console, while still generating multiple lighting effects.

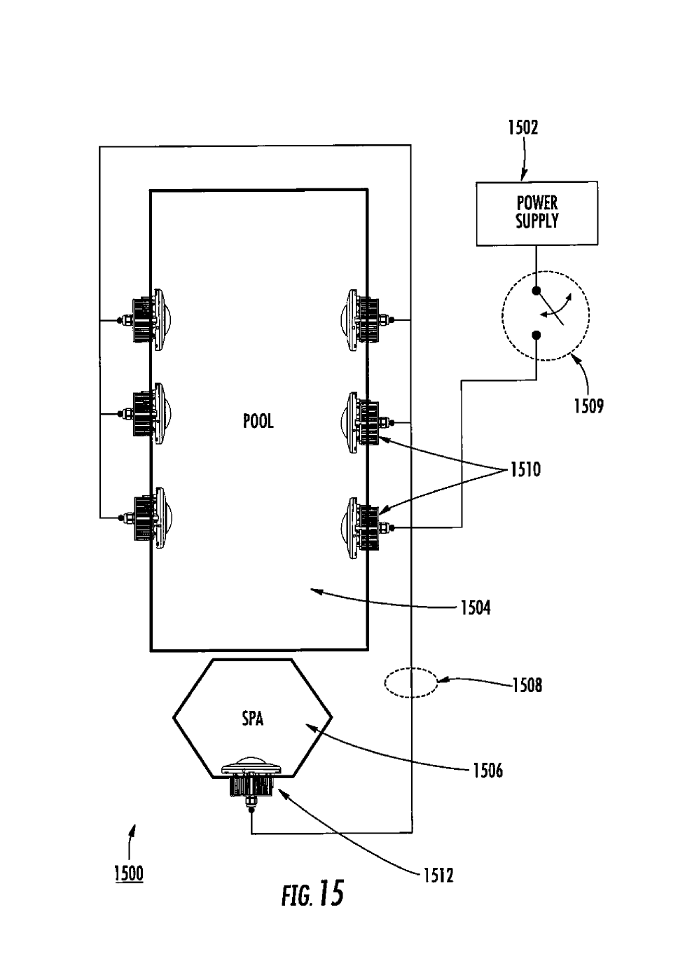

For example, in at least one arrangement the control module 18 of a light fixture 10 can be configured to respond to an electrical signal generated by a user activating and deactivating the light fixture using an electrical switch to cut off the light fixture 10 from the power supply. In at least one arrangement, a standard outlet voltage of 120 VAC can be used to power and control one or more light fixtures 10 using a LED light engine 100, provided a proper electrical transformer is provided within the light fixture 10. However, in other arrangements, the light fixture 10 using an LED light engine 10 can be used with lower voltage systems, such as 12V and 24V systems, without the use of an internal transformer, allowing some flexibility in design or installation. This allows a light fixture 10 to be installed in multiple configurations for existing niches using existing wiring, without requiring the installation or wiring of additional control components. In such arrangements, multiple light fixtures 10 can be connected to a common power supply, allowing a user to adjust the multiple light fixtures 10 simultaneously. An exemplary circuit design showing the various circuit elements for a control module 18 not requiring a control console is shown in FIG. 14.

In arrangements where certain intervals of disruption of power generate electrical power signal patterns, the control module 18 can be further configured to associate at least some of the generated signal patterns with instructions or actions to adjust the light output of the light engine 24. For example, an interruption of power for 1 to 2 seconds can be associated with a first instruction; an interruption of 3 to 5 second can be associated with a second instruction; and so forth. Such instructions can include, but are not limited to, increasing or decreasing the overall illumination intensity of the light engine 24, adjusting the color of an RGB light engine, adjusting the rate of change of light output of the light engine 24, or resetting the light output of the light engine 24 to a default setting. The particular pre-determined interval utilized by the signal patterns can be chosen to facilitate pattern recognition. The pre-determined interval of time can be pre-set or can be user controlled. The present disclosure also contemplates the use of two or more interruption time intervals being used for a signal power signal pattern.

In some arrangements, the control module 18 can be further configured to include a memory element for storing multiple settings for the light engine 24. Where such a memory element is provided, the instructions can also include signaling the control module to switch from one light engine setting in the memory element to another, or signaling the control module to automatically change between light engine settings in the memory element randomly or according to a predefined order. The control module can also be configured to indicate to the user, such as through a visual signal, when the light fixture is reset, for example by flashing the LEDs in the LED light engine 100 according to a pre-defined sequence. Additionally, the control module can also be configured to similarly operate with a control console.

As previously stated, controlling the light output of multiple light fixtures 10, including varying the light output between two or more of the light fixtures 10, can be accomplished by use of a control console providing signals over a lighting network. However, it is also desired to be able to control multiple light fixtures 10 to provide differing light output between two or more of the light fixtures 10 using existing wiring which provides varying illumination in multiple areas without the use of the control console. For example, as shown in FIG. 15, a lighting system 1500 can include a single power supply 1502 providing power to both a first area 1504, such as a pool, and a second area 1506, such as a spa, over a common power supply line 1508 controlled by one or more electrical switches 1509, which is preferably a single electrical switch 1509.

In order to control the illumination of the first and second areas 1504, 1506 separately, one or more light fixtures 1510 installed in the first area 1504 can be configured to respond differently than one or more light fixtures 1512 in the second area 1506 to at least one or more electrical signal patterns transmitted over the common power supply line 1508. For example, light fixtures 1510 in the first area 1504 can be configured to respond to one or more particular signal patterns, while the light fixtures 1512 in the second area 1506 can be configured to ignore or be unresponsive to the same signal patterns, allowing specific commands or instructions to be transmitted to different groups of light fixtures. For example, such commands or instructions can include, but are not limited to, freezing or fixing the current light output of a responsive fixture, deactivating a responsive fixture, or any other command associated with adjusting the light output of a light fixture. Such arrangements can allow a user to provide signal patterns over the common power supply line 1408 and to adjust the light output of fixtures in the first area 1510 without affecting the light output of the fixture in the second area 1512.

In an exemplary process for adjusting the light output in a pool 1504 and an adjacent spa 1506, as shown in FIG. 15, a user can adjust light output in the two areas without the need of a control console by providing only a few signal patterns. First, a user can adjust the light output of all fixtures to a desired light output for the spa 1506 using one or more signal patterns generated using the electrical switch 1509. Afterwards, the user can fix the light output of the fixtures 1512 of the spa 1506 using at least one additional signal pattern, for which only the fixtures in spa 1506 are configured for response. The user can continue adjusting the light output for the fixtures 1510 in the pool area 1504 using additional signal patterns, without affecting the light output pf fixtures 1512 in the spa area 1506. An additional signal pattern instructing all the fixtures to reset to a default light output setting can also be generated to reset the system or to choose a different light output scheme. Although adjustment of light output for fixtures in only two areas has been described, it can be appreciated that in other arrangements, by configuring the control modules of the fixtures in each area to recognize different signal patterns, multiple lighting areas can be defined without the use of a control console or a lighting network.

The exemplary embodiments described herein can use zero crossing counting techniques to control the light fixtures, although other techniques are contemplated by the present disclosure including the use of RC timing circuits. The control system described herein provides for changing of a lighting pattern between synchronous and non-synchronous, as well as resetting of one or more of the light fixtures based upon the use of a single light switch.

In the embodiments of the invention discussed above, various processors and controllers can be implemented in numerous ways, such as with dedicated hardware, or using one or more processors (e.g., microprocessors) that are programmed using software (e.g., microcode) to perform the various functions discussed above. Similarly, storage devices can be implemented in numerous ways, such as, but not limited to, RAM, ROM, PROM, EPROM, EEPROM, CD, DVD, optical disks, floppy disks, magnetic tape, and the like.

For purposes of the present disclosure, the term “LED” refers to any diode or combination of diodes that is capable of receiving an electrical signal and producing a color of light in response to the signal. Thus, the term “LED” as used herein should be understood to include light emitting diodes of all types (including semi-conductor and organic light emitting diodes), semiconductor dies that produce light in response to current, light emitting polymers, electro-luminescent strips, and the like. Furthermore, the term “LED” may refer to a single light emitting device having multiple semiconductor dies that are individually controlled. It should also be understood that the term “LED” does not restrict the package type of an LED; for example, the term “LED” may refer to packaged LEDs, non-packaged LEDs, surface mount LEDs, chip-on-board LEDs, and LEDs of all other configurations. The term “LED” also includes LEDs packaged or associated with other materials (e.g., phosphor, wherein the phosphor may convert radiant energy emitted from the LED to a different wavelength).

Additionally, as used herein, the term “light source” should be understood to include all illumination sources, including, but not limited to, LED-based sources as defined above, incandescent sources (e.g., filament lamps, halogen lamps), pyro-luminescent sources (e.g., flames), candle-luminescent sources (e.g., gas mantles), carbon arc radiation sources, photo-luminescent sources (e.g., gaseous discharge sources), fluorescent sources, phosphorescent sources, high-intensity discharge sources (e.g., sodium vapor, mercury vapor, and metal halide lamps), lasers, electro-luminescent sources, cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers capable of producing primary colors.

For purposes of the present disclosure, the term “light output” should be understood to refer to the production of a frequency (or wavelength) of radiation by an illumination source (e.g., a light source) or the intensity of an illumination source. Furthermore, as used herein, the term “color” should be understood to refer to any frequency (or wavelength) of radiation within a spectrum; namely, “color” refers to frequencies (or wavelengths) not only in the visible spectrum, but also frequencies (or wavelengths) in the infrared, ultraviolet, and other areas of the electromagnetic spectrum.

For purposes of the present disclosure, the term “water feature” is used generally to describe a vessel containing a liquid (e.g., water), that may be used for any number of utilitarian, decorative, entertainment, recreational, therapeutic, or sporting purposes. As used herein, a water may be for human use (e.g., swimming, bathing) or may be particularly designed for use with wildlife (e.g., an aquarium for fish, other aquatic creatures, and/or aquatic plant life). Additionally, a water feature may be man made or naturally occurring and may have a variety of shapes and sizes. Furthermore, a water feature may be constructed above ground or below ground, and may have one or more discrete walls or floors, one or more rounded surfaces, or combinations of discrete walls, floors, and rounded surfaces. Accordingly, it should be appreciated that the term “water feature” as used herein is intended to encompass various examples of water containing vessels such as, but not limited to pools, spas, tubs, sinks, basins, baths, tanks, fish tanks, aquariums and the like.

Similarly, for purposes of the present disclosure, the term “pool” or “spa” is used herein to describe a type of water feature that is particularly designed for a variety of entertainment, recreational, therapeutic purposes and the like. Some other commonly used terms for a spa include, but are not limited to, “hot-tub” and “whirlpool bath.” Generally, a pool or spa may include a number of accessory devices, such as one or more heaters, blowers, jets, circulation and filtration devices to condition water in the water feature, as well as one or more light sources to illuminate the water therein. For purposes of the present disclosure, it also should be appreciated that a water feature as described above may be divided up into one or more sections, and that one or more of the water feature sections can be particularly adapted for use as a spa or a pool.

While the exemplary embodiment of system 1500 describes differentiating signals based upon interruptions of power, it should be understood that signal differentiation can be based on other power parameters such as changes in voltage and/or current. These parameters can be recognized by the control modules and result in varying responses by the light fixtures. The present disclosure also contemplates different parameters being used in combination with each other to establish electrical power signal patterns that are recognizable by the control modules.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

What is claimed is:

1. A light fixture system comprising:
a plurality of light fixtures coupled to a common power supply line, wherein each of the plurality of light fixtures comprises an LED light engine and a control module coupled thereto, the control module being configured to adjust light output settings for the LED light engine based on a plurality of electrical power signal patterns transmitted over the common power supply line,
wherein a first control module of a first light fixture is configured to provide a first response based on a first of the plurality of electrical power signal patterns and a second control module of a second light fixture is configured to provide a second response based on the first of the plurality of electrical power signal patterns, and
wherein the first response comprises the first control module being at least temporarily unresponsive to at least a second of the plurality of electrical power signal patterns.

2. The system of claim 1, wherein each of the plurality of electrical power signal patterns comprises an interruption of electrical power along the common power supply line for a pre-determined interval of time.

3. The system of claim 1, wherein the control module further comprises a memory element having a plurality of light output settings stored therein for the LED light engine.

4. The system of claim 3, wherein at least one light output setting for the LED light engine is retrieved by the control module from the memory element in response to at least one of the plurality of electrical power signal patterns.

5. The system of claim 3, wherein the control module cycles through at least a portion of the plurality of light output settings in response to at least one of the plurality of electrical power signal patterns.

6. The system of claim 5, wherein the control module is configured to provide to a user a visual indication prior to adjustment of the light output setting of the LED engine.

7. The system of claim 1, wherein a third of the plurality of electrical power signal patterns resets all of the plurality of light fixtures to a default light output setting.

8. The system of claim 1, wherein the control module further comprises a memory element, and wherein a fourth of the plurality of electrical power signal patterns resets the plurality of light fixtures to a last selected configuration stored in the memory element.

9. The system of claim 1, wherein at least one of the plurality of light fixtures is a submersible light fixture.

10. The system of claim 9, further comprising a bracket for installation of the submersible light fixture outside of a niche.

11. A method of adjusting light output in a submersible light fixture system, the method comprising:
coupling a plurality of fixtures to a common power supply line, wherein at least one of the plurality of fixtures is a submersible light fixture, wherein each of the plurality of fixtures comprises an LED light engine coupled to a control module;
transmitting a plurality of electrical power signal patterns along the common power supply line to the plurality of fixtures,
wherein each of the control modules is configured to adjust light output settings for the LED light engine coupled thereto in response to at least a portion of the plurality of electrical power signal patterns,
wherein a first control module of a first fixture is configured to provide a first response based on a first of the plurality of electrical power signal patterns and a second control module of a second fixture is configured to provide a second response based on the first of the plurality of electrical power signal patterns, and
wherein the first response comprises the first control module being at least temporarily unresponsive to at least a second of the plurality of electrical power signal patterns.

12. The method of claim 11, wherein each of the plurality of electrical power signal patterns comprises an interruption of electrical power along the common power supply line for a pre-determined interval of time.

13. The method of claim 11, wherein the control module further comprises a memory element having a plurality of light output settings for the LED light engine stored therein.

14. The method of claim 13, wherein at least one light output setting for the LED light engine is retrieved by the control module from the memory element in response to the at least a portion of the plurality of electrical power signal patterns.

15. The method of claim 13, wherein the control module automatically cycles through at least a portion of the plurality of light output settings in response to at least one of the portion of the plurality of electrical power signal patterns.

16. The method of claim 15, wherein the control module is further configured to provide a visual signal to a user prior to setting the light output of the LED engine to an initial one of the plurality of light output settings.

17. A method of adjusting a light output of a plurality of submersible light fixtures installed in multiple areas, the method comprising:
electrically coupling the plurality of submersible light fixtures to a common power supply line, wherein each one the plurality of submersible light fixtures comprises an LED light engine coupled to a control module, wherein the common power supply line is coupled to a power supply using at least one switch, and wherein the control module for each one of the plurality of submersible light fixtures is configured to adjust light output settings of the coupled LED light engine in response to at least one of a plurality of power signal patterns transmitted along the common power supply line; and
generating the plurality of power signal patterns by opening and closing of the at least one switch for a pre-determined interval of time,
wherein a first power signal pattern is generated based on a first pre-determined interval of time, the first power signal pattern adjusting the light output of the plurality of submersible light fixtures to a first light output setting, and
wherein a second power signal pattern is generated based on a second pre-determined interval of time, the second power signal pattern adjusting the light output of at least one of the plurality of submersible light fixtures to a second light output setting and causing at least another of the plurality of submersible light fixtures to be at least temporarily unresponsive to subsequent power signal patterns.

18. The method of claim 17, wherein the control module further comprises a memory element having a plurality of light output settings for the LED light engine stored therein, wherein at least one light output setting for the LED light engine is retrieved by the control module from the memory element in response to at least one of the plurality of power signal patterns.

19. The method of claim 17, wherein the control module further comprises a memory element having a plurality of light output settings for the LED light engine stored therein, wherein the control module cycles through at least a portion of said plurality of light output settings in response to at least one of the plurality of power signal patterns.

20. The method of claim 17, wherein the control module further comprises a memory element having a plurality of light output settings for the LED light engine stored therein, wherein the control module is further configured to provide a visual signal a user prior to setting the light output setting of the LED engine to an initial one of said plurality of light output settings.
